(19) United States
(12) Patent Application Publication
(10) Pub. No.: US 2024/0342043 A1
(43) Pub. Date: Oct. 17, 2024

(54) CORE OF MASSAGER AND MASSAGER

(71) Applicant: Aukey Technology Co., Ltd., Shenzhen (CN)

(72) Inventor: Xigen Xiao, Shenzhen (CN)

(21) Appl. No.: 18/632,499

(22) Filed: Apr. 11, 2024

(30) Foreign Application Priority Data
Apr. 14, 2023 (DE) 20 2023 101 897.1

(51) Int. Cl. A61H 7/00

(52) U.S. Cl. CPC A61H 7/007; A61H 2201/0149; A61H 2201/1215; A61H 2201/1481; A61H 2201/1666; A61H 2201/5007; A61H 2201/5028; A61H 2201/503; A61H 2201/5064

(57) ABSTRACT

The application discloses a core of massager and a massager which comprise a shell, a driving assembly, two transmission assemblies and two massaging assemblies, the shell has a first opening and a second opening on both sides; the driving assembly comprises a driving source arranged in the shell and a rotating shaft connected with the driving source; the two transmission assemblies, connected to two ends of the rotating shaft, comprise a first eccentric wheel, a second eccentric wheel and a positioning wheel, all sleeved on the rotating shaft, the positioning wheel and the first eccentric wheel form an oblique space; the two massaging assemblies respectively extend out of the first and second openings, comprise a first massaging arm arranged in the oblique space and sleeved on the first eccentric wheel, a second massaging arm sleeved on the second eccentric wheel and pivotally connected to the shell via a connecting rod.

The present application claims priority to Germany Patent Application No. 202023101897.1, filed with the Germany Patent Office on Apr. 14, 2023, titled “CORE OF MASSAGER”, the entire contents of which are incorporated herein by reference.

### TECHNICAL FIELD

Embodiments of the present invention relate to the technical field of massage equipment, and in particular, relate to a core of massager and a massager.

### BACKGROUND

The essential part of a massage apparatus is the core of massager located in the middle, which is the source of massage power and the mechanism for implementing the massage action. At present, there are many kinds of cores of massagers on the market, and all the existing cores of massagers are driven by motors and transmission devices to operate kneading massage heads. The core of a neck and shoulder massager is a massage apparatus for massaging the shoulder and the neck, muscles of the neck and the shoulder can be massaged and relaxed within a short time by using the neck and shoulder massager, and continuous use of the massager can effectively relieve pain symptoms.

However, during the realization of the present application, the inventor found that the core of massagers currently available on the market has a complex structure and a large volume, and the massaging heads thereof are generally located on the same plane, so multidimensional massage cannot be well realized and the massage effect on the neck is poor.

### SUMMARY

In order to solve the above technical problems, an embodiment of the present invention provides a core of massager with a simple structure and a small volume, which adopts multi-directional massaging heads to realize multidimensional massage on the neck.

To solve the technical problems, the following technical solution of the embodiment of the present invention provides a core of massager, which comprises:

a shell, two sides of which are respectively provided with a first opening and a second opening;

a driving assembly, comprising a driving source arranged in the shell and a rotating shaft connected with an output end of the driving source, and two ends of the rotating shaft being respectively exposed from the first opening and the second opening;

two transmission assemblies, being respectively connected to the two ends of the rotating shaft, wherein each of the transmission assemblies comprises a first eccentric wheel, a second eccentric wheel and a positioning wheel which are respectively sleeved on the rotating shaft, and an oblique space is formed between the positioning wheel and the first eccentric wheel; and

two massaging assemblies, respectively extending out of the first opening and the second opening, wherein one of the massaging assemblies is connected to one of the transmission assemblies, and each of the massaging assemblies comprises:

a first massaging arm sleeved on the first eccentric wheel, the first massaging arm being arranged in the oblique space so that the first massaging arm has a deflection amplitude;

a first massaging head connected to a tail end of the first massaging arm;

a second massaging arm sleeved on the second eccentric wheel;

a second massaging head connected to a tail end of the second massaging arm; and

a connecting rod pivotally connected to the second massaging arm and movably connected to the shell so that the second massaging arm has a deflection amplitude.

An embodiment of the present application further provides a massager, which comprises:

a shell, two sides of which are respectively provided with a first opening and a second opening;

a driving assembly, comprising a driving source arranged in the shell and a rotating shaft connected with an output end of the driving source, and two ends of the rotating shaft are respectively exposed from the first opening and the second opening;

two transmission assemblies, being respectively connected to the two ends of the rotating shaft;

two massaging assemblies, respectively extending out of the first opening and the second opening, one of the massaging assemblies being connected to one of the transmission assemblies;

a position sensor, comprising a first part arranged in the shell and a second part arranged on the transmission assembly or the massaging assembly, wherein the first part is configured to send a specific signal when the second part moves to a specific position; and

a main control board, comprising a control unit which is electrically connected with the driving source and the position sensor respectively, wherein the control unit is configured to control the driving source to work in response to a trigger signal and control the driving source to stop working after receiving the specific signal output by the position sensor.

Beneficial effects of the embodiments of the present invention are as follows.

As compared to the prior art, according to the core of massager and the massaging head provided by the embodiments of the present application, the first massaging arm is arranged in the oblique space, so that the rotation of the first massaging arm with the rotating shaft enables left-and-right reciprocating motion with deflection amplitude; in addition, one end of the connecting rod is movably connected to the shell, and the other end of the connecting rod is pivotally connected to the second massaging arm, so that when the rotating shaft rotates, the second massaging arm is driven by the connecting rod to enable back-and-forth reciprocating motion with deflection amplitude, thereby providing multi-directional massage, realizing multidimensional massage on the neck and improving the massage effect. In addition, through the arrangement of the position sensor, massage can be stopped when the spacing distance between the two massaging assemblies is the largest or the smallest, so that the risk of injury to the massaged part due to excessive squeezing to the massaged part can be reduced, and meanwhile, the probability that the massaging assemblies fail to touch the massaged part can be reduced, thereby improving the user experience.

### BRIEF DESCRIPTION OF THE DRAWINGS

In order to explain the technical solutions of the embodiments of the present invention more clearly, attached drawings required in the embodiments of the present invention will be briefly introduced hereinafter. Obviously, the attached drawings described below are only some embodiments of the present invention, and other drawings can be obtained by those of ordinary skill in the art according to these attached drawings without making creative efforts.

FIG. 1 is a schematic structural diagram of a core of massager according to an embodiment of the present invention.

FIG. 2 is a schematic structural diagram of the core of massager shown in FIG. 1 with a cover plate opened.

FIG. 3 is a schematic structural diagram of the core of massager shown in FIG. 1 with the shell removed.

FIG. 4 is a schematic structural diagram of the shell in the core of massager shown in FIG. 1.

FIG. 5 is an exploded schematic view of the core of massager shown in FIG. 1.

FIG. 6 is a top view of the core of massager shown in FIG. 1 with components in the power supply assembly and the driving assembly removed except for a rotating shaft.

FIG. 7 is a cross-sectional view of FIG. 6 taken along line A-A.

FIG. 8 is a top view of the core of massager shown in FIG. 1 with the shell and the power supply assembly removed.

FIG. 9 is a cross-sectional view of FIG. 8 taken along line B-B.

FIG. 10A and FIG. 10B show the core of massager with the largest spacing distance between massaging heads.

FIG. 11A and FIG. 11B show the core of massager with the minimum spacing distance between massaging heads.

FIG. 12A and FIG. 12B are schematic structural diagrams in which only the first massaging arm in FIG. 5 remains.

### REFERENCE NUMERALS

100: Core of massager; 300: Oblique space;
10: Shell; 101: First opening; 102: Second opening; 11: First shell; 12: Second shell;
13: Pedestal; 131: Third limiting groove; 132: Fourth limiting groove;
14: Accommodating groove; 15: Cover plate;
20: Driving assembly; 21: Driving source; 22: Rotating shaft; 23: Stop pin; 24: Worm; 25: Gear set; 26: Third shell; 27: Fourth shell;
30: Transmission assembly;
31: First eccentric wheel; 311: First shaft hole; 312: First annular boss; 313: First limiting groove;
32: Second eccentric wheel; 321: Second shaft hole; 322: Second annular boss; 323: Boss; 324: Second limiting groove;
33: Positioning wheel; 331: Third shaft hole;
40: Massaging assembly;
41: First massaging arm; 411: First shaft sleeve; 412: Third shaft sleeve; 413: First pivot; 414: Second pivot;
42: Second massaging arm; 421: Second shaft sleeve; 422: Fifth limiting groove;
43: First massaging head; 431: Lower massaging head; 432: Upper massaging head;
44: Second massaging head; 45: Connecting rod; 46: limiting column;
50: Power supply assembly;
60: Main control board; 610: Control unit;
70: Button;
80: Position sensor; 810: First part; 820: Second part.

### DETAILED DESCRIPTION

In order to facilitate the understanding of the present invention, the present invention will be described in more detail hereinafter with reference to the attached drawings and specific embodiments. It shall be noted that when an element is said to be “fixed”/“connected” to another element, it may be directly on the other element, or there may be one or more intervening elements therebetween. When an element is said to be “connected” to another element, it may be directly connected to the other element, or there may be one or more intervening elements therebetween. Terms such as “both ends” and “middle part” used in this specification indicate orientation or positional relationships based on the orientation or positional relationships shown in the attached drawings, and those terms are only provided for the convenience of describing the present application and simplifying the description, and do not indicate or imply that the devices or elements referred to must have a specific orientation or must be constructed and operated in a specific orientation, so these terms should not be construed as limitations to the present invention. In addition, terms such as “first” and “second” are only used for descriptive purposes and should not be construed as indicating or implying relative importance.

Unless otherwise defined, all technical and scientific terms used in this specification have the same meaning as commonly understood by those skilled in the art to which the present invention belongs. The terms used in the specification of the present invention are only for the purpose of describing specific embodiments and are not intended to limit the present invention.

In addition, technical features involved in different embodiments of the present application described below may be combined with each other as long as they do not conflict with each other.

In addition, technical features involved in different embodiments of the present invention described below may be combined with each other as long as they do not conflict with each other.

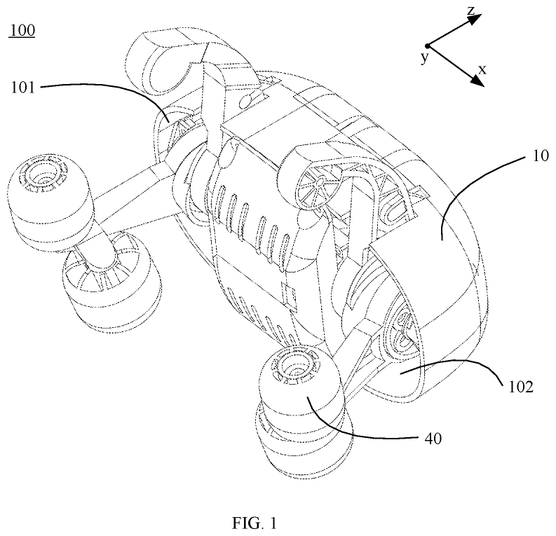

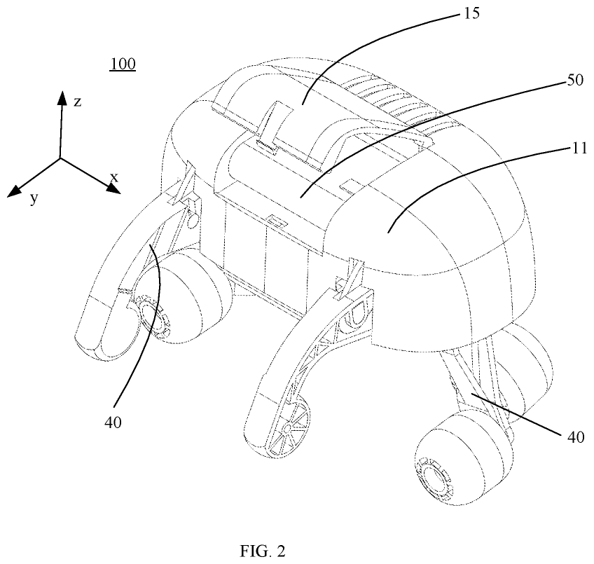

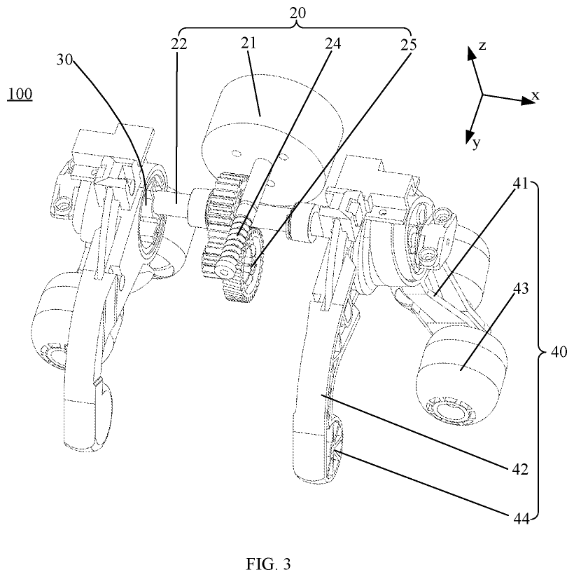

Referring to FIG. 1 to FIG. 3 together, FIG. 1 is a perspective view of a core of massager 100 provided according to one embodiment of the present invention, FIG. 2 is a schematic view of the core of massager 100 shown in FIG. 1 in the state where the cover plate 15 is opened, and FIG. 3 is a schematic structural diagram of the core of massager 100 shown in FIG. 1 with the shell 10 removed. The core of massager 100 comprises a shell 10, a driving assembly 20, two transmission assemblies 30, two massaging assemblies 40 and a power supply assembly 50, both the driving assembly 20 and the power supply assembly 50 are installed in the shell 10, both the two transmission assemblies 30 are installed on the driving assembly 20, one of the massaging assemblies 40 is installed on one of the transmission assemblies 30, the driving assembly 20 is used to drive the transmission assembly 30 to drive the massaging assembly 40 to massage the human body, and the power supply assembly 50 is used to supply power to the driving assembly 20.

The above-mentioned core of massager 100 may be applied to massage chairs, massage shawls or the like, and no specific limitation is made thereto by the present application as long as the massage function of the present application can be realized.

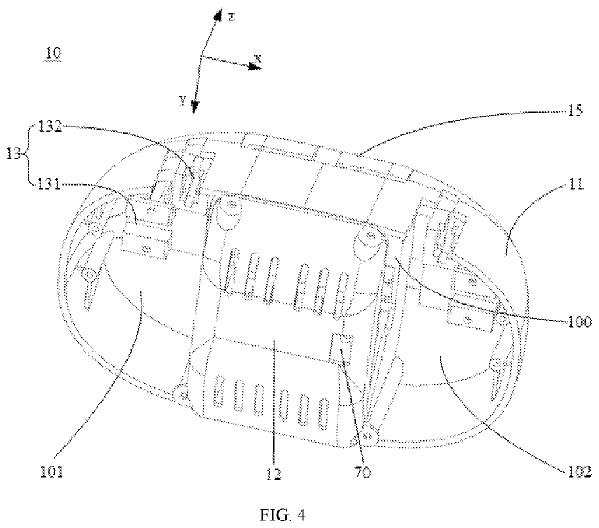

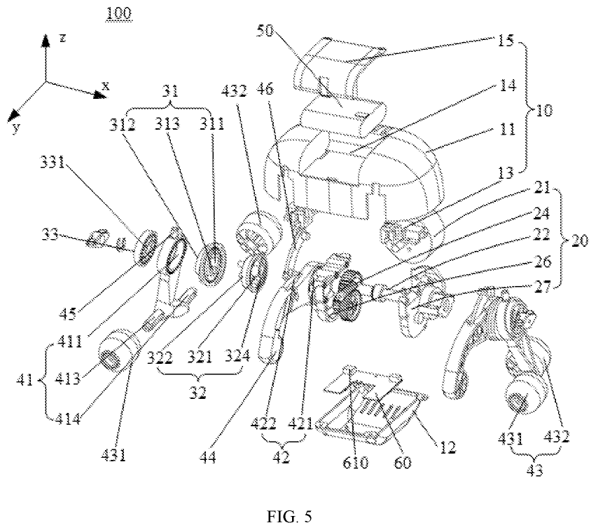

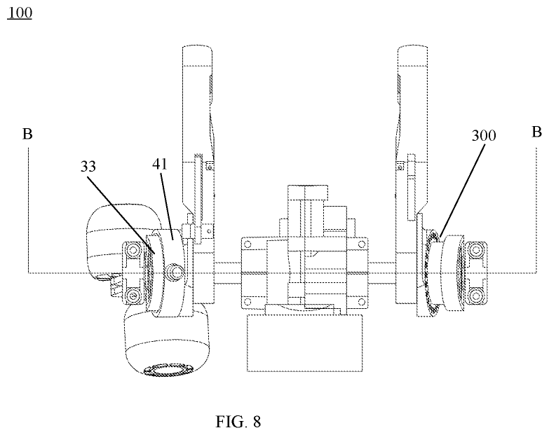

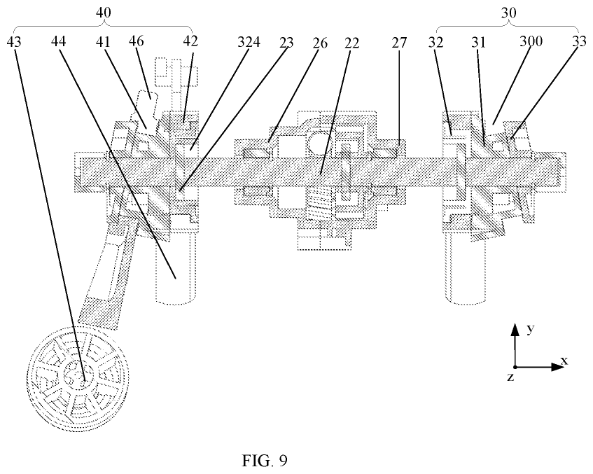

Referring to FIG. 4 and FIG. 5, two sides of the shell 10 are respectively provided with a first opening 101 and a second opening 102, the driving assembly 20 comprises a driving source 21 arranged in the shell 10 and a rotating shaft 22 connected with an output end of the driving source 21, two ends of the rotating shaft 22 are respectively exposed from the first opening 101 and the second opening 102, and the two transmission assemblies 30 are connected with the two ends of the rotating shaft 22 respectively. In this way, under the driving of the driving source 21, each massaging assembly 40 is controlled to perform reciprocating motion with deflection amplitude through the mechanical linkage of the rotating shaft 22 and the transmission assemblies 30. Specifically, a transmission assembly 30 comprises a first eccentric wheel 31, a second eccentric wheel 32 and a positioning wheel 33 which are respectively sleeved on the rotating shaft 22, an oblique space 300 is formed between the positioning wheel 33 and the first eccentric wheel 31 (see also FIG. 8 and FIG. 9), the two massaging assemblies 40 extend out of the first opening 101 and the second opening 102 respectively, one massaging assembly 40 is connected to one transmission assembly 30, and one massaging assembly 40 comprises a first massaging arm 41 sleeved on the first eccentric wheel 31, a second massaging arm 42 sleeved on the second eccentric wheel 32, a first massaging head 43 connected to a tail end of the first massaging arm 41, and a second massaging head 44 connected to a tail end of the second massaging arm 42. The first massaging arm 41 is arranged in the oblique space 300, so that the first massaging arm 41 is driven by the driving source 21 to perform reciprocating motion with deflection amplitude through the mechanical linkage of the rotating shaft 22 and the transmission assembly 30. A connecting rod 45 is pivotally connected to the second massaging arm 42 and movably connected to the shell 10, so that the second massaging arm 42 is driven by the driving source 21 to perform reciprocating motion with deflection amplitude through the mechanical linkage of the rotating shaft 22 and the transmission assemblies 40.

It shall be noted that, an oblique space 300 is formed between the positioning wheel 33 and the first eccentric wheel 31. Specifically, the first eccentric wheel 31 and the positioning wheel 33 respectively form an oblique intersection with the rotating shaft 22 at a certain angle, that is, both the first eccentric wheel 31 and the positioning wheel 33 have inclined planes so that an oblique space 300 (oblique with respect to the rotating shaft 22) is formed between the first eccentric wheel 31 and the positioning wheel 33. Thus, the first massaging arm 41 may be driven to form certain swing amplitude instead of straight swing when the first eccentric wheel 31 and the positioning wheel 33 rotate.

The core of massager provided according to the embodiment of the present invention has a simple structure. By arranging the first massaging arm 41 in the oblique space 300 between the positioning wheel 33 and the first eccentric wheel 31, left-and-right reciprocating motion with deflection amplitude of the first massaging arm 41 is realized, and the second massaging arm 42 is driven to perform back-and-forth reciprocating motion with deflection amplitude through the movement of the connecting rod 45, thereby liberating hands to realize multidimensional massage on the neck and improving the massage effect.

In the embodiment of the present application, the left-right direction x is the direction in which the first eccentric wheel 31 extends to the second eccentric wheel 32, the up-down direction z is the direction in which a first shell 11 extends to a second shell 12, and the front-back direction y is the direction perpendicular to both x and z. It is worth noting that the axial direction of the rotating shaft 22 is the left-right direction x.

As shall be appreciated, the above-mentioned transmission assemblies 30 and massaging assemblies 40 may also be arranged in four or six groups or the like. For example, there are four groups of transmission assemblies and four groups of massaging assemblies, one massaging assembly is connected to one transmission assembly, two ends of the rotating shaft are each provided with two groups of massaging assemblies, the two groups of massaging assemblies at one end of the rotating shaft are arranged at intervals, and both the two groups of massaging assemblies at one end of the rotating shaft extend out of the first opening/the second opening.

As shall be appreciated, the two transmission assemblies have the same structure, and the two massaging assemblies also have the same structure. For convenience of description, the transmission assembly and the massaging assembly located on one side of the rotating shaft will be described as examples, and for example, the transmission assembly and the massaging assembly located on the left side of the rotating shaft will be described as examples.

In some embodiments, as shown in FIG. 4, the shell 10 comprises a first shell 11, a second shell 12 and two pedestals 13 fixed to the first shell 11 at intervals, the first shell 11 and the second shell 12 are enclosed together to form an accommodation space, and the driving assembly 20 is arranged in the accommodation space. The first opening 101 and the second opening 102 are respectively located at the left and right sides of the accommodation space, the two pedestals 13 are exposed from the first opening 101 and the second opening 102 respectively, and the connecting rod 45 is movably connected to the pedestals 13.

In some embodiments, as shown in FIG. 5, the shell 10 further comprises an accommodating groove 14, and the power supply assembly 50 is placed in the accommodating groove 14. For example, the power supply assembly 50 is a battery which may be a rechargeable battery. In another embodiment, the core of massager 100 may also be in the form without a built-in battery, for example, power may be supplied from the outside through any one or a combination of power transmission wires, power supply interfaces and power adapters.

In some embodiments, the accommodating groove 14 is concavely formed in the direction in which the first shell 11 extends to the second shell 12.

In some embodiments, the shell 10 further comprises a cover plate 15 for covering the accommodating groove 14 so as to seal the power supply assembly 50 in the accommodating groove 14, thereby preventing the power supply assembly 50 from being exposed outside and causing potential safety hazards.

In some embodiments, in order to facilitate the disassembly of the power supply assembly 50, the cover plate 15 is detachably connected to the accommodating groove 14. For example, one end of the cover plate 15 is hinged with the shell 11, and the other end of the cover plate 15 is buckled to the first shell 11.

In some embodiments, as shown in FIG. 5, each of the first eccentric wheel 31, the second eccentric wheel 32 and the positioning wheel 33 is provided with a shaft hole through which the rotating shaft 22 passes. Specifically, the first eccentric wheel 31 is provided with a first shaft hole 311, the second eccentric wheel 32 is provided with a second shaft hole 321, the positioning wheel 33 is provided with a third shaft hole 331, and the first shaft hole 311, the second shaft hole 321 and the third shaft hole 331 are all used for the rotating shaft 22 to pass through.

In order to drive the first eccentric wheel 31, the second eccentric wheel 32, the first massaging arm 41 sleeved on the first eccentric wheel 31 and the second massaging arm 42 sleeved on the second eccentric wheel 32 to rotate together when the rotating shaft 22 rotates, it is necessary to axially fix the first eccentric wheel 31, the second eccentric wheel 32, the first massaging arm 41 and the second massaging arm 42 relative to the rotating shaft 22. Please refer to the following description for details.

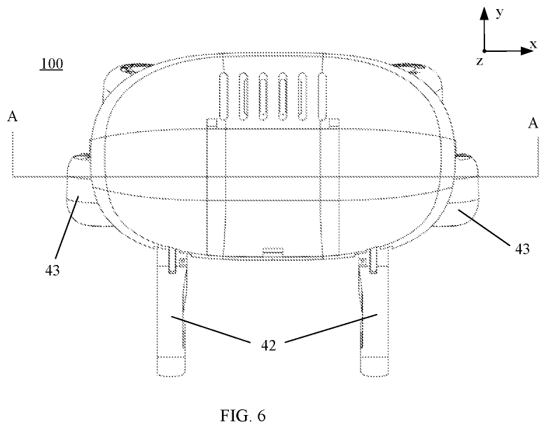

As shown in FIG. 5 to FIG. 7, first ends of the first eccentric wheel 31 and the second eccentric wheel 32 are respectively provided with a first annular boss 312 and a second annular boss 322, the first massaging arm 41 and the second massaging arm 42 are respectively formed with a first shaft sleeve 411 and a second shaft sleeve 421 through which the first annular boss 312 and the second annular boss 322 pass, and the first annular boss 312 and the second annular boss 322 surround the first shaft hole 311 and the second shaft hole 321 respectively, so that the first massaging arm 41 may rotate together with the first eccentric wheel 31 and the second massaging arm 42 may rotate together with the second eccentric wheel 32.

As shall be appreciated, the first shaft hole 311 penetrates through the first annular boss 312 and the second shaft hole 321 penetrates through the second annular boss 322.

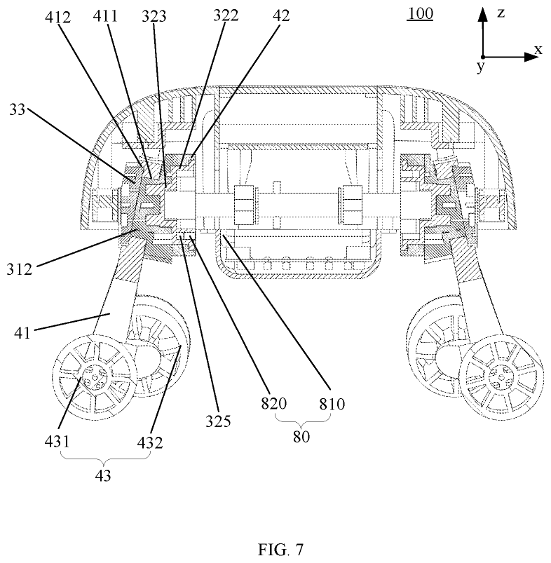

In some embodiments, a second end of the first eccentric wheel 31 is provided with a first limiting groove 313, the first end of the second eccentric wheel 32 is provided with a boss 323 (see FIG. 7) at the position corresponding to the first limiting groove 313, the first limiting groove 313 is configured to accommodate the boss 323, and the boss 323 is arranged on the second annular boss 322, so as to limit the rotation of the first eccentric wheel 31 relative to the second eccentric wheel 32 so that the second eccentric wheel 32 may rotate synchronously with the first eccentric wheel 31.

In some embodiments, the first limiting groove 313 is semi-annular, and the boss 323 is a semi-annular boss matched with the semi-annular first limiting groove 313.

In some embodiments, the first limiting groove 313 communicates with the second shaft hole 321.

As shall be appreciated, in an embodiment, the first limiting groove 313 may not communicate with the second shaft hole 321, as long as the shape of the boss 323 is matched with the shape of the first limiting groove 313 to limit the relative rotation between the second eccentric wheel 32 and the first eccentric wheel 31.

In some embodiments, the positioning wheel 33 is fixed to the first end of the first eccentric wheel 31, so that the positioning wheel 33 and the first eccentric wheel 31 may rotate synchronously and thus the first massaging arm 41 may rotate together with the rotating shaft 22.

In some embodiments, as shown in FIG. 7, in order to reduce the length of the core of massager 100, the first massaging arm 41 is provided with a third shaft sleeve 412, and the positioning wheel 33 is partially accommodated in the third shaft sleeve 412.

With the above structure, when the driving source 21 drives the rotating shaft 22 to rotate, the first eccentric wheel 31 and the second eccentric wheel 32 may drive the first massaging arm 41 and the second massaging arm 42 to rotate synchronously.

In some embodiments, as shown in FIG. 8 and FIG. 9, the transmission assembly 30 comprises a stopper pin 23 which is arranged on the rotating shaft 22, the second end of the second eccentric wheel 32 is provided with a second limiting groove 324, and the stopper pin 23 is accommodated in the second limiting groove 324, thereby limiting the rotation of the second eccentric wheel 32 relative to the rotating shaft 22 so that the second eccentric wheel 32 may rotate together with the rotating shaft 22.

In some embodiments, as shown in FIG. 5, the second limiting groove 324 has a shape of horizontal strip and communicates with the second shaft hole 321 of the second eccentric wheel 32.

With the above structure, when the rotating shaft 22 rotates, the first eccentric wheel 31 drives the first massaging arm 41 to swing left and right, and the second eccentric wheel 32 drives the second massaging arm 42 to swing back and forth synchronously.

In some embodiments, as shown in FIG. 4 and FIG. 5, in order to restrict the movement of the first massaging arm 41 in the up-down direction z, a limiting column 46 is arranged at the top of the first massaging arm 41, a third limiting groove 131 is provided on the pedestal 13 of the shell 10, and the limiting column 46 is arranged in the third limiting groove 131. Specifically, when the rotating shaft 22 rotates, the positioning wheel 33 and the first eccentric wheel 31 also rotate with the rotating shaft 22 because both the first eccentric wheel 31 and the positioning wheel 33 are installed on the rotating shaft 22, and the oblique space 300 formed between the first eccentric wheel 31 and the positioning wheel 33 also changes in spatial position with the rotation of the rotating shaft 22. The first massaging arm 41 is located in the oblique space 300, so that the first massaging arm 41 also twists with the rotation of the rotating shaft 22, and then movement of the first massaging arm 41 is limited to the third limiting groove 131 by the limiting column 46 so that the first massaging arm 41 only twists in the left-right direction x (and in this way, the first massaging arm 41 can pinch and massage the neck).

In some embodiments, as shown in FIG. 4, the third limiting groove 131 has a shape of horizontal strip along the left-right direction x (the direction in which the first eccentric wheel extends to the second eccentric wheel).

As shall be appreciated, the amplitude of the left-right swing of the first massaging arm 41 is the length of the third limiting groove 131 in the left-right direction x.

In some embodiments, as shown in FIG. 5, in order to make the kneading by the first massaging arm 41 more comfortable, the end of the first massaging arm 41 is connected with a first pivot 413 and a second pivot 414, the first massaging head 43 comprises a lower massaging head 431 and an upper massaging head 432, the first pivot 413 is connected with the lower massaging head 431 and the second pivot 414 is connected with the upper massaging head 432, so that two massaging heads are provided on each of the left and right sides of the core of massager 100, i.e., four massaging heads jointly pinch and massage the neck.

It shall be noted that, the lower massaging head 431 is located closer to the second massaging head 44 than the upper massaging head 432 in the front-back direction y.

In some embodiments, both the lower massaging head 431 and the upper massaging head 432 are made of rubber material, and the second massaging head 44 is also made of rubber or plastic material.

In some embodiments, as shown in FIG. 4, the pedestal 13 of the shell 10 is provided with a fourth limiting groove 132, a first end of the connecting rod 45 is pivotally connected to the second massaging arm 42, and a second end of the connecting rod 45 is rotatably connected to the fourth limiting groove 132. For example, the second end of the connecting rod 45 is opened with a hole, the aforesaid fourth limiting groove 132 is also opened with a hole, the second end of the connecting rod 45 is placed in the fourth limiting groove 132, and a pin shaft passes through the hole of the fourth limiting groove 132 and the hole on the connecting rod 45 in sequence so that the connecting rode 45 is hinged with the fourth limiting groove 132.

In some embodiments, in order to make the second massaging arm 42 swing more softly, the bottom surface of the fourth limiting groove 132 is an arc-shaped surface, and the connecting rod 45 is an arc-shaped structure. When the rotating shaft 22 rotates, the second massaging arm 42 performs a back-and-forth reciprocating motion with deflection amplitude so as to massage the neck of the human body. Specifically, when the rotating shaft 22 rotates, the second eccentric wheel 32 also rotates with the rotating shaft 22 because the second eccentric wheel 32 is fixedly installed on the rotating shaft 22. Since one end of the second massaging arm 42 is sleeved on the second eccentric wheel 32 and the other end of the second massaging arm 42 is pivotally connected to the first end of the connecting rod 45, the second massaging arm 42 drives the connecting rod 45 to move when the second eccentric wheel 32 rotates. Furthermore, the second end of the connecting rod 45 is rotatably connected to the fourth limiting groove 132 of the pedestal 13, and thus the connecting rod 45 swings around the joint between the pedestal 13 and the connecting rod 45. When the connecting rod 45 rotates around the joint, the second massaging arm 42 performs back-and-forth reciprocating motion with deflection amplitude, so as to massage the neck in the front-back direction y.

It shall be noted that, the bottom surface of the fourth limiting groove 132 refers to the end of the fourth limiting groove 132 far away from the first opening 101.

In some embodiments, as shown in FIG. 5, the second massaging arm 42 is provided with a fifth limiting groove 422, and the first end of the connecting rod 45 is pivotally connected to the fifth limiting groove 422. For example, the first end of the connecting rod 45 is opened with a hole, the side wall of the fifth limiting groove 422 is also opened with a hole, the first end of the connecting rod 45 is arranged in the fifth limiting groove 422, and a pin shaft passes through the hole on the side wall of the fifth limiting groove 422 and the hole on the first end of the connecting rod 45 in sequence so that the connecting rod 45 is hinged with the fifth limiting groove 422.

As shall be appreciated, the notch of the fifth limiting groove 422 faces the first opening 101.

In some embodiments, the bottom surface of the fifth limiting groove 422 is an arc-shaped surface. It shall be noted that, the bottom surface of the fifth limiting groove 422 refers to the end of the fifth limiting groove 422 far away from the first opening 101. In the core of massager 100 according to the present disclosure, the first massaging arm 41 is arranged in the oblique space 300, so that the first massaging arm 41 performs left-and-right reciprocating motion with deflection amplitude along with the rotation of the rotating shaft 22. In addition, the second end of the connecting rod 45 is movably connected to the shell 10, and the first end of the connecting rod 45 is pivotally connected to the second massaging arm 42, so that when the rotating shaft 22 rotates, the connecting rod 45 drives the second massaging arm 42 to perform back-and-forth reciprocating motion with deflection amplitude, thereby providing multi-directional massage to realize multidimensional massage on the neck and improving the massage effect.

In some embodiments, as shown in FIG. 3 and FIG. 5, the driving assembly 20 further comprises a worm 24 and a gear set 25, one end of the worm 24 is connected with the output end of the driving source 21, and the other end of the worm 24 is engaged with the gear set 25, and at least one gear in the gear set 25 is axially fixed in the middle part of the rotating shaft 22, so that the rotating shaft 22 is driven to rotate by the rotation of the gear fixed on the rotating shaft 22. The middle part of the rotating shaft 22 refers to the part between the two ends of the rotating shaft 22, that is, the gear fixed on the rotating shaft 22 is located between the first opening 101 and the second opening 102 in the left-right direction x.

The gear set 25 described above may have only one gear or a plurality of gears. For example, the gear set 25 has only one gear which is axially fixed on the rotating shaft 22, one end of the worm 24 is connected with the output end of the driving source 21, and the other end of the worm 24 is engaged with the gear, so that when the driving source 21 drives the worm 24 to rotate, the worm 24 drives the gear and the rotating shaft 22 to rotate synchronously. Alternatively, the aforesaid gear set 25 comprises three gears, namely a first gear, a second gear and a third gear respectively, wherein the first gear is axially fixed on the rotating shaft 22, the first gear is engaged with the second gear, the second gear is axially fixed on the third gear, one end of the worm 24 is connected with the output end of the driving source 21, the other end of the worm 24 is engaged with the third gear, and the third gear is rotatably connected with the shell 10.

As shall be appreciated, the above-mentioned driving assembly 20 may not comprise the gear set 25, or the above-mentioned driving assembly 20 comprises neither the gear set 25 nor the worm 24. For example, the middle part of the rotating shaft 22 is provided with teeth in the circumferential direction, one end of the worm 24 is connected with the output end of the driving source 21, and the other end of the worm 24 is engaged with the teeth on the rotating shaft 22, so that when the driving source 21 drives the worm 24 to rotate, the worm 24 drives the gear set 25 and the rotating shaft 22 to rotate synchronously. Alternatively, the output end of the driving source 21 is directly connected with the rotating shaft 22, so that the rotating shaft 22 is directly driven to rotate by the driving source 21.

Of course, the above gear set may also be replaced by other transmission mechanisms, and any scheme capable of driving the above rotating shaft to rotate shall fall within the scope claimed in the present invention.

In some embodiments, the aforesaid driving source 21 is a motor, and the power supply assembly 50 is electrically connected with the driving source 21.

In some embodiments, as shown in FIG. 5 and FIG. 9, the aforesaid driving assembly 20 further comprises a third shell 26 and a fourth shell 27 which are interlocked with each other, and the worm 24 and the gear set 25 are all accommodated in the space enclosed by the third shell 26 and the fourth shell 27 so as to prevent the gear set 25 from being exposed to the outside and then getting corroded and thus prolong the service life of the gear set 25.

As shall be appreciated, the outer wall enclosed by the third shell 26 and the fourth shell 27 is provided with a hole through which the rotating shaft 22 passes, and the outer wall enclosed by the third shell 26 and the fourth shell 27 is also provided with a hole through which the output end of the driving source 21 passes.

In some embodiments, as shown in FIG. 4 and FIG. 5, the core of massager 100 further comprises a main control board 60 and a button 70 electrically connected to the main control board 60, the power supply assembly 50 is electrically connected to the main control board 60 and the button 70 respectively, the power supply assembly 50 can supply power to the main control board 60 and the button 70, and the button 70 is electrically connected to the driving source 21 and used for turning on and turning off the driving source 21.

In some embodiments, the button 70 is a mechanical switch or a touch switch. As shall be appreciated, the button 70 is exposed on the shell 10 for convenience of manual operation.

In some embodiments, the main control board 60 is electrically connected with the driving source 21, and the main control board 60 is configured to control the driving source 21 to operate in response to a trigger signal and/or a start signal. For example, the button 70 described above is triggered to generate a trigger signal and/or a start signal.

Further speaking, the main control board 60 comprises a control unit 610 which is electrically connected with the above-mentioned driving source 21, and the control unit 610 is configured to control the driving source 21 to operate in response to a trigger signal and/or a start signal. For example, in the actual operation of powering on, the button 70 is touched or pressed to generate a start signal, and the control unit 610 controls the driving source 21 to be turned on in response to the start signal, so that under the driving of the driving source 21, the first massaging arm 41 is controlled to perform left-and-right reciprocating motion with deflection amplitude and the second massaging arm 42 is controlled to perform a back-and-forth reciprocating motion with deflection amplitude through the mechanical linkage of the rotating shaft 22 and the transmission assemblies 30.

In some embodiments, the main control board 60 is a PCB board.

In some embodiments, the main control board 60 has a built-in Bluetooth module or a wifi module, and the core of massager 100 can be remotely controlled by an external intelligent device. For example, the external intelligent device is connected with the Bluetooth module or the wifi module so as to control the operation of the driving source 21.

In some embodiments, in order to prevent excessive heat being generated during the operation of the core of massager 100, the shell 10 is further provided with heat dissipation holes.

After adopting the above structure, during the operation of the core of massager 100 according to the embodiment of the present application, the massaging assemblies 40 on both sides of the rotating shaft 22 simultaneously perform reciprocating motion with deflection amplitude, wherein the first massaging arms 41 on both sides perform reciprocating pinching actions, while the second massaging arms 42 on both sides perform reciprocating massaging actions, thereby imitating the massage mode of human hands to realize massaging and pinching actions with certain deflection, and making the massage softer and more comfortable.

Furthermore, in order to diversify the massage manipulation, in addition to synchronous deflection between two massaging assemblies 40 in which the massaging arms of the massaging assemblies 40 on the left and right sides move in opposite directions, the corresponding massaging arms of two massaging assemblies 40 may also be chosen to realize asynchronous deflection, thereby increasing the massage experience and improving the massage effect. For example, the structure of the left massaging assembly remains unchanged, and the structure of the right massaging assembly is slightly optimized, so that when the rotation direction of the rotating shaft 22 changes, the first massaging arm and the second massaging arm of the right massaging assembly and the first massaging arm and the second massaging arm of the left massaging assembly may swing asynchronously, thereby realizing different massage modes.

Specifically, the second limiting groove of the second eccentric wheel in the right massaging assembly is provided in the shape of an annular segment, for example, two sides of the semi-annular second limiting groove form a first stop surface, and one end of the right stop pin on the rotating shaft 22 is connected with the rotating shaft, and the other end of the right stop pin protrudes out of the rotating shaft so as to drive the second eccentric wheel to rotate after the stop pin is stopped by the first stop surface. Similarly, two sides of the first limiting groove of the first eccentric wheel form a second stop surface, and one end of the boss on the second eccentric wheel that is matched with the first limiting groove is changed to be connected with the rotating shaft, and the other end of the boss protrudes out of the stop pin of the rotating shaft so as to drive the first eccentric wheel to rotate after the stop pin is stopped by the second stop surface. For example, in this embodiment, the first limiting groove and the second limiting groove may be semi-annular and are respectively communicated with the first shaft hole of the first eccentric wheel and the second shaft hole of the second eccentric wheel, so that the stop pin can only abut against the corresponding stop surface to realize the pushing effect after rotating with the rotating shaft for half a cycle, thereby enabling the rotating shaft to drive the sleeved first eccentric wheel and the second eccentric wheel to rotate.

In practical application scenarios, when the user stops or suspends the use of the core of massager or the massager, it is difficult to release parts to be massaged such as the neck and legs from between the two massaging assemblies 40 if the spacing distance between the two massaging assemblies 40 (along the left-right direction x) is too small. In addition, when the user prepares to use the core of massager 100 or the massager, it is not easy to place parts to be massaged such as the neck and legs between the two massaging assemblies 40 if the spacing distance between the two massaging assemblies 40 (along the left-right direction x) is too small. Therefore, the core of massager 100 of the present disclosure further comprises a position sensor 80 electrically connected with the main control board 60, and for example, the position sensor 80 is electrically connected with the control unit 610. Specifically, as shown in FIG. 7, the position sensor 80 comprises a first part 810 provided on the shell 10 and a second part 820 provided on the transmission assembly 20 or the massaging assembly 40, and for example, the second part 820 is provided on the second eccentric wheel 32 or the positioning wheel 33. The first part 810 is configured to send a specific signal when the second part 820 moves to a specific position, and the control unit 610 is configured to control the driving source 21 to stop working after receiving the aforesaid specific signal.

In some embodiments, the aforesaid position sensor 80 is a Hall sensor, and for example, the first part 810 is a magnetic induction unit and the second part 820 is a magnetic piece. The above-mentioned specific position refers to the position where the second part 820 faces the first part 810, and at this point, the spacing distance between the two massaging assemblies 40 is the largest in the left-right direction x. That is, when the spacing distance between the two massaging assemblies 40 is the largest, the second part 820 is in a position facing the first part 810, and the first part 810 in the position sensor 80 outputs the above-mentioned specific signal.

As shall be appreciated, in other embodiments, the position sensor 80 described above may also be a photoelectric sensor.

The embodiment of the present application will be described by taking the case where the position sensor 80 is a Hall sensor as an example.

In a specific embodiment, a corresponding positioning hole is provided in one of the two massaging assemblies 40 or one of the two transmission assemblies 30, and meanwhile, the second part 820 (the magnetic piece) is provided in the positioning hole, and a mounting part for installing the first part 810 (the magnetic induction unit) is provided on the shell 10. In order to ensure that the magnetic induction unit may operate under the influence of the magnetic piece, the magnetic piece is arranged adjacent to the magnetic induction unit in the present disclosure. For example, as shown in FIG. 7, an embodiment of the present disclosure shows that the second eccentric wheel 32 is opened with a corresponding first positioning hole 325 (the positioning holes provided on the second eccentric wheel 32 and the positioning wheel 33 are defined as the first positioning holes in order to be distinguished from the positioning holes provided on the second massaging arm 42), and the second part 820 (the magnetic piece) is installed in the first positioning hole 325. Correspondingly, a mounting part is provided at the position of the second shell 12 that is near the second eccentric wheel 32, and the first part 810 (the magnetic induction unit) may be fixed by the mounting part.

During the operation of the core of massager 100, through the first positioning hole 325 arranged on the second eccentric wheel 32, the second part 820 (the magnetic piece) fixedly arranged in the first positioning hole 325, the mounting part arranged on the second shell 12 and the first part 810 (the magnetic induction unit) mounted on the mounting part, the magnetic induction unit is configured to sense the magnetic field change of the magnetic piece so as to generate an electrical signal, and at the same time, the magnetic induction unit is connected with the control unit 610 (as shown in the FIG. 5). When the second eccentric wheel 32 is driven to rotate by the driving assembly 20, the magnetic induction unit will generate a corresponding specific signal (of a high level or a low level) when the spacing distance between the two first massaging arms 41 is the largest in the left-right direction x during the process in which the second eccentric wheel 32 rotates for a cycle, and the control unit 610 will control the driving source 21 to stop working based on the specific signal. For example, when the spacing between the two massaging arms 41 is the largest, the magnetic induction unit generates a current signal of low level, and then the control unit 610 controls the driving source 21 to stop working.

In the actual operation of powering off or suspension, when the user is ready to stop or suspend the use of the core of massager 100 or the massager, the user may operate the button 70 to stop or suspend the operation of the core of massager or the massager. At this time, the button 70 is touched or pressed to generate a trigger signal, and the control unit 610 controls the driving source 21 to continue to work in response to the trigger signal, so that under the driving of the driving source 21, the first massaging arm 41 is controlled to perform left-and-right reciprocating motion with deflection amplitude and the second massaging arm 42 is controlled to perform back-and-forth reciprocating motion with deflection amplitude through the mechanical linkage of the rotating shaft 22 and the transmission assemblies 30 and usually within one cycle of reciprocating motion. When the magnetic induction unit of the position sensor 80 generates a current signal of low level, the control unit 610 controls the driving source 21 to stop working based on the current signal of low level. At this point, the spacing distance (in the left-right direction x) between the two massaging assemblies 40 is the largest, so that it is convenient for the user to release parts to be massaged such as the neck and legs from between the two massaging assemblies 40, and it is also convenient for the user to place parts to be massaged such as the neck and legs between the two massaging assemblies 40 when preparing to use the core of massager 100 or the massager again.

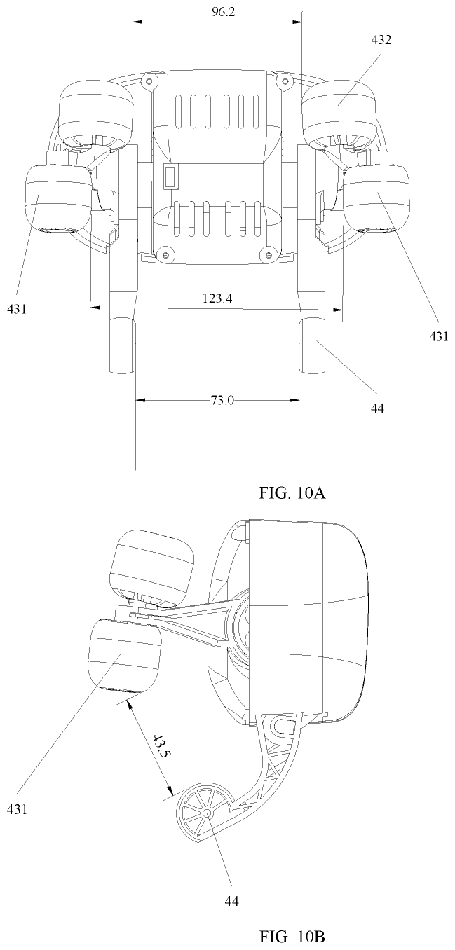

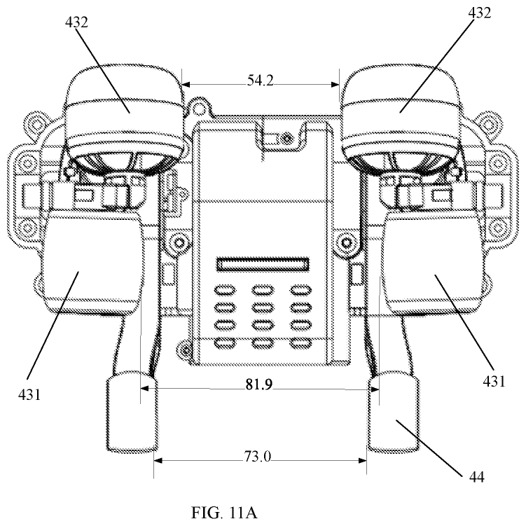

In one embodiment, based on the control to the massaging assembly 40 by the magnetic piece and the magnetic induction unit described above, the maximum spacing distance between the lower massaging heads 431 on both sides in the left-right direction x may be any value between 121.4 mm and 125.4 mm, e.g., 123.4 mm, as shown in FIG. 10A. In the left-right direction x, the minimum spacing distance between the lower massaging heads 431 on both sides may be any value between 79.9 mm and 83.9 mm, e.g., 81.9 mm, as shown in FIG. 11A. In the left-right direction x, the maximum spacing distance between the upper massaging heads 432 on both sides may be any value between 94.2 mm and 98.2 mm, e.g., 96.2 mm, as shown in FIG. 10A. In the left-right direction x, the minimum spacing distance between the upper massaging heads 432 on both sides may be any value between 52.2 mm and 56.2 mm, e.g., 54.2 mm, as shown in FIG. 11A. The maximum spacing distance between the lower massaging head 431 and the second massaging head 44 located on the same side (such as the left side) may be any value between 41.5 mm and 45.5 mm, e.g., 43.5 mm, as shown in FIG. 10B. The minimum spacing distance between the lower massaging head 431 and the second massaging head 44 located on the same side (such as the left side) may be any value between 19.7 mm and 23.7 mm, e.g., 21.7 mm, as shown in FIG. 11B.

In one embodiment, as shown in FIG. 7, when the second eccentric wheel 32 is provided with a magnetic piece, a corresponding magnetic induction unit may also be provided on the main control board 60 to combine the magnetic induction unit with the control board 60. For example, the magnetic induction unit is integrated into the main control board 60, thereby further simplifying the overall structure of the core of massager 100.

In one embodiment, the aforesaid positioning hole and the second part 820 (the magnetic piece) may also be provided on the positioning wheel 33, and for example, the positioning hole is provided on the side of the positioning wheel 33 far away from the first eccentric wheel 31. At this time, the first part 810 (the magnetic induction unit) is correspondingly arranged on one side of the first shell 11 that is close to the positioning wheel 33, and for example, a mounting part is arranged at the position of the first shell 11 that is close to the positioning wheel 33, and the first part 810 (the magnetic induction unit) may be fixed by the mounting part. In another embodiment, the mounting part may not be provided on the shell 10, and for example, the mounting part may be fixed to fixing components at both ends of the rotating shaft 22.

In one embodiment, the aforesaid positioning hole and the second part 820 (the magnetic piece) may also be provided on the second massaging arm 42, and for example, a protrusion is provided on the second shaft sleeve 421, and a corresponding positioning hole and the magnetic piece are provided on the protrusion. At this time, the setting of the mounting part and the setting of the first part 810 (the magnetic induction unit) are basically consistent with those in the case where the positioning hole is provided on the second eccentric wheel 32, and only the height of the mounting part on the second shell 12 needs to be correspondingly adjusted to ensure that the magnetic induction unit fixed on the mounting part is adjacent to the magnetic piece.

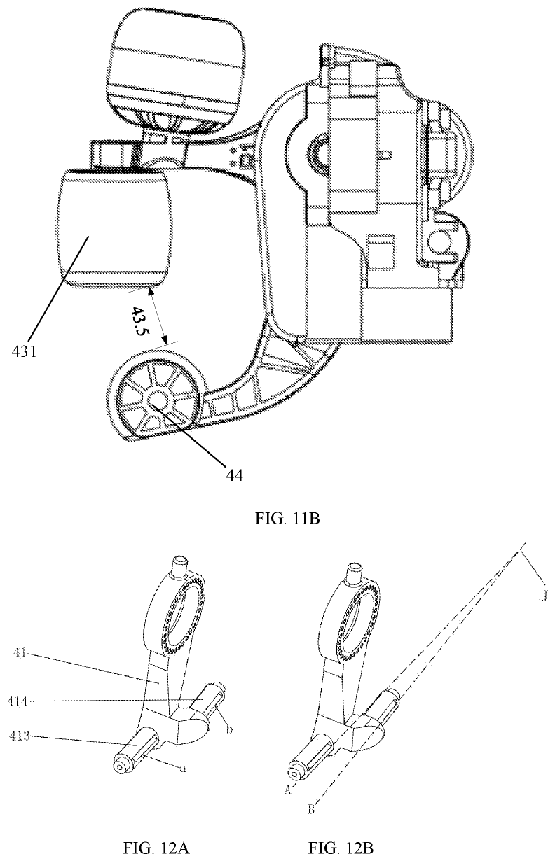

In one embodiment, as shown in FIG. 12A and FIG. 12B, an extended line A and an extended line B are respectively made on the basis of a line segment a on the first pivot 413 and a line segment b on the second pivot 414, and finally the extended line A and the extended line B intersect at a point J, that is, the first pivot 413 and the second pivot 414 are not arranged parallel. The first pivot 413 and the second pivot 414 are respectively arranged on both sides of the first massaging arm 41 in the front-back direction y. Moreover, in the case where the first pivot 413 and the second pivot 414 are dislocated and not arranged in parallel, a certain dislocation space can be formed between the lower massaging head 431 on the first pivot 413 and the upper massaging head 432 on the second pivot 414. Further in combination with the second massaging head 44, a three-dimensional space with a certain volume may be formed among the lower massaging head 431, the upper massaging head 432 and the second massaging head 44. Further making use of the cooperation of the driving assembly 20, the transmission assembly 30 and the massaging assembly 40 in the core of massager 100 in combination with the variability of the positions and distances among the massaging heads, three-dimensional massage experience can be achieved on the massaged parts by the lower massaging head 431, the upper massaging head 432 and the second massaging head 44, thereby improving the massage effect.

An embodiment of the present application further provides a massager, which comprises the aforesaid core of massager 100.

The core of massager and the massager provided according to the embodiments of the present invention are simple in structure, and by arranging the first massaging arm in the oblique space between the positioning wheel and the first eccentric wheel, the left-and-right reciprocating motion with deflection amplitude of the first massaging arm is realized, and in addition, the second massaging arm is driven by the connecting rod to perform back-and-forth reciprocating motion with deflection amplitude, thereby liberating the hands to provide multi-directional massage and realize multidimensional massage on the neck, and meanwhile improving the massage effect. In addition, by the arrangement of the position sensor, the massage can be stopped when the spacing distance between the two massaging assemblies is the largest or the smallest, thereby reducing the risk of excessive squeezing to the massaged part or the probability that the massaged part is not touched, and meanwhile improving the user experience.

Finally it shall be noted that, the above embodiments are only used to describe but not to limit the technical solutions of the present invention; and within the spirits of the present invention, technical features of the above embodiments or different embodiments may also be combined with each other, the steps may be implemented in an arbitrary order, and many other variations in different aspects of the present invention described above are possible although, for purpose of simplicity, they are not provided in the details. Although the present invention has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not essentially depart from the scope of the technical solutions of embodiments of the present invention due to such modifications or substations.

1. A core of massager, comprising:
a shell, two sides of which are respectively provided with a first opening and a second opening;
a driving assembly, comprising a driving source arranged in the shell and a rotating shaft connected with an output end of the driving source, and two ends of the rotating shaft being respectively exposed from the first opening and the second opening;
two transmission assemblies, being respectively connected to the two ends of the rotating shaft, wherein each of the transmission assemblies comprises a first eccentric wheel, a second eccentric wheel and a positioning wheel which are respectively sleeved on the rotating shaft, and an oblique space is formed between the positioning wheel and the first eccentric wheel; and
two massaging assemblies, respectively extending out of the first opening and the second opening, wherein one of the massaging assemblies is connected to one of the transmission assemblies, and each of the massaging assemblies comprises:
a first massaging arm sleeved on the first eccentric wheel, the first massaging arm being arranged in the oblique space so that the first massaging arm has a deflection amplitude;
a first massaging head connected to a tail end of the first massaging arm;
a second massaging arm sleeved on the second eccentric wheel;
a second massaging head connected to a tail end of the second massaging arm; and
a connecting rod pivotally connected to the second massaging arm and movably connected to the shell so that the second massaging arm has a deflection amplitude.

2. The core of massager according to claim 1, wherein first ends of the first eccentric wheel and the second eccentric wheel are respectively provided with a first annular boss and a second annular boss, and the first massaging arm and the second massaging arm are respectively formed with a first shaft sleeve and a second shaft sleeve through which the first annular boss and the second annular boss pass, so that the first massaging arm rotates with the first eccentric wheel and the second massaging arm rotates with the second eccentric wheel.

3. The core of massager according to claim 2, wherein a second end of the first eccentric wheel is provided with a first limiting groove, the first end of the second eccentric wheel is provided with a boss matched with the first limiting groove, the first limiting groove is configured to accommodate the boss, and the boss is arranged on the second annular boss so that the first eccentric wheel rotates together with the second eccentric wheel.

4. The core of massager according to claim 1, wherein the transmission assembly comprises a stop pin; the stop pin is arranged on the rotating shaft, a second end of the second eccentric wheel is provided with a second limiting groove, and the stop pin is accommodated within the second limiting groove so that the second eccentric wheel rotates together with the rotating shaft.

5. The core of massager according to claim 1, wherein the positioning wheel is fixed at the first end of the first eccentric wheel so that the positioning wheel rotates together with the first eccentric wheel.

6. The core of massager according to claim 1, wherein the driving assembly further comprises a worm and a gear set, one end of the worm is connected with the output end of the driving source, the other end of the worm is engaged with the gear set, and at least one gear in the gear set is sleeved on the rotating shaft.

7. The core of massager according to claim 1, wherein the shell is provided with a third limiting groove, and a limiting column is arranged at the top of the first massaging arm and movably connected to the third limiting groove.

8. The core of massager according to claim 1, wherein the shell is provided with a fourth limiting groove, and the connecting rod is rotatably connected to the fourth limiting groove.

9. The core of massager according to claim 8, wherein the bottom surface of the fourth limiting groove is an arc-shaped surface.

10. The core of massager according to claim 1, wherein the second massaging arm is provided with a fifth limiting groove, and the connecting rod is pivotally connected to the fifth limiting groove.

11. The core of massager according to claim 1, wherein the core of massager further comprising:
a position sensor, comprising a first part arranged in the shell and a second part arranged on the second eccentric wheel or the positioning wheel, wherein the first part is configured to send a specific signal when the second part moves to a specific position; and
a main control board, being electrically connected with the driving source and the position sensor respectively, and being configured to control the driving source to continue working in response to a trigger signal and control the driving source to stop working after receiving the specific signal output by the position sensor.

12. A massager, comprising:
a shell, two sides of which are respectively provided with a first opening and a second opening;
a driving assembly, comprising a driving source arranged in the shell and a rotating shaft connected with an output end of the driving source, and two ends of the rotating shaft being respectively exposed from the first opening and the second opening;
two transmission assemblies, being respectively connected to the two ends of the rotating shaft;
two massaging assemblies, respectively extending out of the first opening and the second opening, one of the massaging assemblies being connected to one of the transmission assemblies;
a position sensor, comprising a first part arranged in the shell and a second part arranged on the transmission assembly or the massaging assembly, the first part being configured to send a specific signal when the second part moves to a specific position; and
a main control board, comprising a control unit which is electrically connected with the driving source and the position sensor respectively, wherein the control unit is configured to control the driving source to continue working in response to a trigger signal and control the driving source to stop working after receiving the specific signal output by the position sensor.

13. The massager according to claim 12, wherein the massager further comprises a button electrically connected with the control unit, the button is arranged on the shell, and the button is triggered to generate the trigger signal.

14. The massager according to claim 13, wherein the button is a mechanical switch or a touch switch.

15. The massager according to claim 12, wherein each of the massaging assemblies is controlled to perform a reciprocating motion with deflection amplitude through a mechanical linkage of the rotating shaft and the transmission assemblies under the driving of the driving source.

16. The massager according to claim 15, wherein the position sensor outputs the specific signal when the spacing distance between the two massaging assemblies is the largest along an axial direction of the rotating shaft.

17. The massager according to claim 16, wherein the position sensor is a Hall sensor, the second part is a magnetic piece, the first part is a magnetic induction unit, and the magnetic induction unit is electrically connected with the control unit.

18. The massager according to claim 12, wherein
each of the transmission assemblies comprises a first eccentric wheel and a positioning wheel which are respectively sleeved on the rotating shaft, and an oblique space is formed between the positioning wheel and the first eccentric wheel;
each of the massaging assemblies comprises a first massaging arm sleeved on the first eccentric wheel and a first massaging head connected to an tail end of the first massaging arm, and the first massaging arm is arranged in the oblique space, so that each of first massaging arm is controlled to perform the reciprocating motion with a deflection amplitude through the mechanical linkage of the rotating shaft and the transmission assemblies under the driving of the driving source.

19. The massager according to claim 18, wherein each of the transmission assemblies further comprises a second eccentric wheel, each of the massaging assemblies further comprises a second massaging arm sleeved on the second eccentric wheel, a second massaging head connected to a tail end of the second massaging arm, and a connecting rod pivotally connected to the second massaging arm, and the connecting rod is movably connected to the shell, so that each of the second massaging arm is controlled to perform the reciprocating motion with the deflection amplitude through the mechanical linkage of the rotating shaft and the transmission assemblies under the driving of the driving source.

20. The massager according to claim 19, wherein
each of the first massaging head comprises a lower massaging head and an upper massaging head;
wherein along the axial direction of the rotating shaft, a minimum spacing distance between the lower massaging heads on both sides is any value between 79.9 mm and 83.9 mm, and a maximum spacing distance between the lower massaging heads on both sides is any value between 121.4 mm and 125.4 mm;
along the axial direction of the rotating shaft, a minimum spacing distance between the upper massaging heads on both sides is any value between 52.2 mm and 56.2 mm, and a maximum spacing distance between the upper massaging heads on both sides is any value between 94.2 mm and 98.2 mm;
a minimum spacing distance between each of the lower massaging head and the second massaging head on the same side is any value between 19.7 mm and 23.7 mm, and a maximum spacing distance between each of the lower massaging head and the second massaging head on the same side is any value between 41.5 mm and 45.5 mm.
